(19) United States
(12) Patent Application Publication
(10) Pub. No.: US 2006/0245050 A1
(43) Pub. Date: Nov. 2, 2006

(54) Image device

(75) Inventors: Tomohiro Uchida, Hachioji-shi (JP); Makoto Araki, Hachioji-shi (JP); Kenji Sasaki, Hino-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/401,712

(22) Filed: Apr. 11, 2006

(30) Foreign Application Priority Data
Apr. 13, 2005 (JP) 2005-115972

(51) Int. Cl. G02B 21/26

(52) U.S. Cl. 359/391

(57) ABSTRACT

An imaging device includes an imager including an optical receiver, an optical element located on an optical path extending to the optical receiver, a substrate to which the imager is fixed, a casing which covers the imager and the optical element, and a dustproof light-shielding member interposed between the imager and the optical element. The dustproof light-shielding member has an opening which allows light to pass, and a fitting portion formed like a recess in which the imager is to be fitted. The dustproof light-shielding member is held between the imager and the optical element to form a sealed space, protecting a space between the imager and the optical element against dust.

### CROSS-REFERENCE TO RELATED APPLICATIONS

This application is based upon and claims the benefit of priority from prior Japanese Patent Application No. 2005-115972, filed Apr. 13, 2005, the entire contents of which are incorporated herein by reference.

### BACKGROUND OF THE INVENTION

1. Field of the Invention

The present invention relates to an imaging device.

2. Description of the Related Art

A conventional CCD mounting structure will be described with reference to FIG. 18. The conventional CCD mounting structure, which is used when mounting a. CCD 100 covered with a cover glass 120 and having an optical receiver to a video camera or the like, includes a sensor substrate 810 on which the CCD 100 is mounted, a box-like sensor shield 800 which covers the CCD 100 together with the sensor substrate 810, a holder 820 to which an LPF 300 to be set in front of an optical receiver of the CCD 100 is attached, and a dustproof member 900 which is interposed between the cover glass 120 and LPF 300.

The sensor shield is for covering the CCD to shield it from light so that unwanted external light will not enter the CCD. The dustproof member is for causing the space between the cover glass and LPF to be a shielded space where fine dust in air will not enter.

Japanese Patent No. 3034995 discloses a CCD mounting structure. The CCD mounting structure comprises a CCD with an optical receiver covered with a cover glass, a holder on which the CCD is mounted, an LPF which faces the opening of the holder and opposes the optical receiver, and a dustproof light-shielding member which is interposed between the LPF and CCD. The dustproof light-shielding member, which is made of an elastic, opaque material, has an opening which allows external light to pass, an inner bank provided around the opening, an outer bank provided outside the inner bank, and a fitting portion into which a rear end of the LPF is to be fitted. The inner bank is brought into contact with the cover glass, and the outer bank with a package of the CCD. The holder is configured to have a recess to house the LPF and a projecting ridge surrounding it slightly outside the recess and to hold the fitting portion of the dustproof light-shielding member between the projecting ridge and LPF.

The above invention, which is aimed at overall downsizing, weight reduction, and cost reduction, adds a light-shielding function for the CCD to the dustproof member of the CCD to eliminate a light-shielding shield member, and a positioning function for the LPF and dustproof member to decrease the number of assembly steps.

The dustproof light-shielding member has the fitting portion that can fix the LPF, to facilitate positioning of the LPF and dustproof light-shielding member. On that surface of the dustproof light-shielding member which is to come into contact with the CCD, bank-like steps are formed around a lid cover and a package that covers the CCD. This improves the contact to improve the light-shielding properties and dustproof properties.

Japanese Pat. Appln. KOKAI Publication No. 6-85221 discloses a solid-state imaging device using a laminated ceramic package. This solid-state imaging device includes a light-shielding plate which covers a solid-state imager except for a portion above an effective pixel region in order to prevent any unwanted light or bright light from being received by the solid-state imager and suppresses flare of the image. From the viewpoint of improving the productivity, a CERDIP type solid-state imaging device may be possible in which a lead frame is clamped by filling a space between a ceramic base and a lid with an adhesive. However, this apparatus does not include a layer to place the light-shielding plate. Therefore, it is difficult to arrange the light-shielding plate above the solid-state imager accurately.

As a solution to readily arrange the light-shielding plate above the solid-state imager, the light-shielding plate is directly mounted on the base through support pieces. With this structure, the light-shielding plate can be attached highly accurately with reference to the upper surface of the base. Therefore, the gap between the solid-state imager and light-shielding plate can be set accurately. If the light-shielding plate and the support pieces are molded integrally, the light-shielding plate can be attached readily. With this application, the cost can be reduced while maintaining the light-shielding properties. Consequently, the degrees of freedom in selection of the package increase.

### BRIEF SUMMARY OF THE INVENTION

According to an aspect of the invention, there is provided an imaging device comprising an imager including an optical receiver, an optical element located on an optical path extending to the optical receiver, a substrate to which the imager is fixed, a casing which covers the imager and the optical element, and a dustproof light-shielding member interposed between the imager and the optical element. The dustproof light-shielding member includes an opening which allows light to pass, and a fitting portion formed like a recess in which the imager is to be fitted. The dustproof light-shielding member is held between the imager and the optical element to form a sealed space, protecting a space between the imager and the optical element against dust.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of an imaging device according to the first embodiment of the present invention;

FIG. 2 is a cross-sectional view taken along the line II-II of the imaging device shown in FIG. 1;

FIG. 3 is a longitudinal sectional view taken along the line III-III of the imaging device shown in FIG. 1;

FIG. 4 is a plan view of the CCD alone shown in FIG. 1;

FIG. 5 shows the dustproof light-shielding member shown in FIGS. 2 and 3;

FIG. 6 is a cross-sectional view of an imaging device according to the second embodiment of the present invention;

FIG. 7 shows the dustproof light-shielding member shown in FIG. 6;

FIG. 8 is a cross-sectional view of an imaging device according to a modification to the second embodiment of the present invention;

FIG. 9 shows the dustproof light-shielding member shown in FIG. 8;

FIG. 10 is a cross-sectional view of an imaging device according to the third embodiment of the present invention;

FIG. 11 shows the dustproof light-shielding member shown in FIG. 10;

FIG. 12 is a cross-sectional view of an imaging device according to the fourth embodiment of the present invention;

FIG. 13 shows the dustproof light-shielding member shown in FIG. 12;

FIG. 14 is a cross-sectional view of an imaging device according to the fourth embodiment of the present invention;

FIG. 15 shows the dustproof light-shielding member shown in FIG. 14;

FIG. 16 is a cross-sectional view of an imaging device according to the sixth embodiment of the present invention;

FIG. 17 shows the dustproof light-shielding member shown in FIG. 16; and

FIG. 18 schematically shows a conventional CCD mounting structure.

### DETAILED DESCRIPTION OF THE INVENTION

The embodiments of the present invention will be described with reference to the accompanying drawing.

### First Embodiment

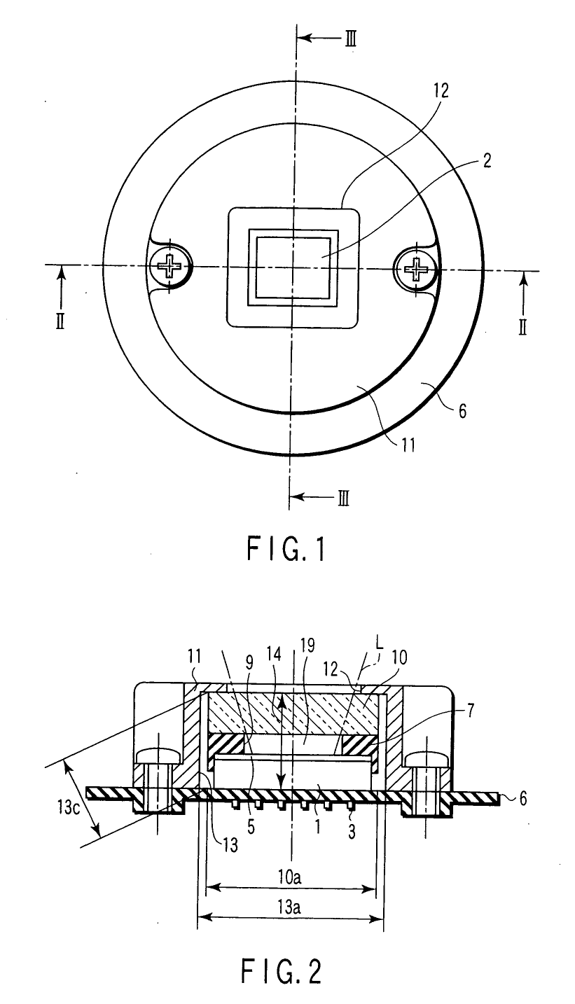

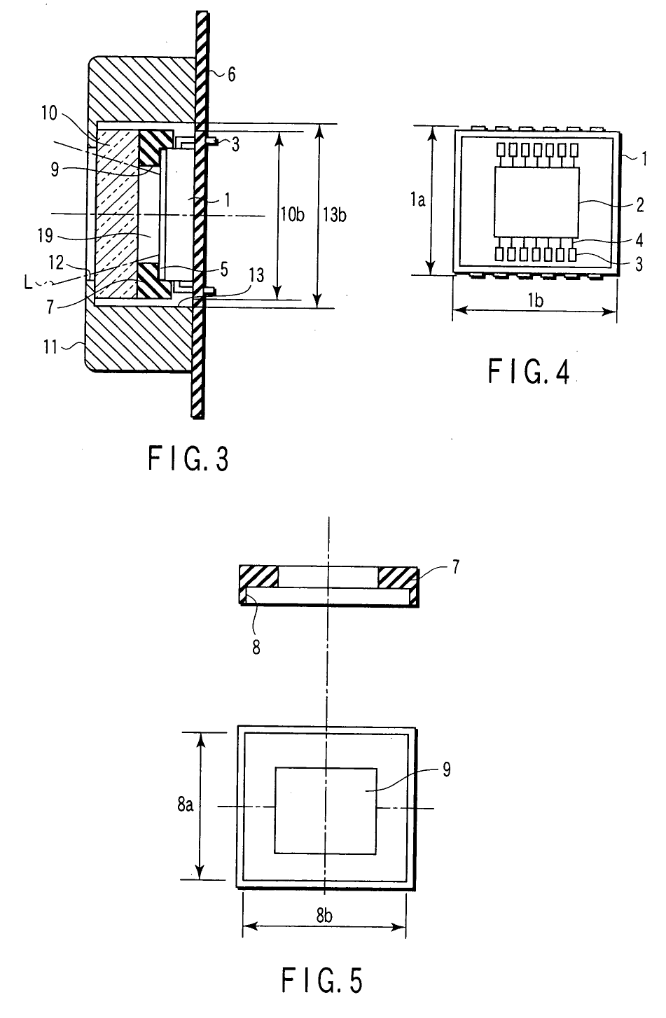

FIG. 1 is a plan view of an imaging device according to the first embodiment of the present invention. FIG. 2 is a cross-sectional view taken along the line II-II of the imaging device shown in FIG. 1. FIG. 3 is a longitudinal sectional view taken along the line III-III of the imaging device shown in FIG. 1. FIG. 4 is a plan view of the CCD alone shown in FIG. 1.

As shown in FIGS. 1, 2, and 3, the imaging device comprises a CCD 1 as an imager, an optical element 10, a dustproof light-shielding member 7 interposed between the CCD 1 and optical element 10, a substrate 6 to which CCD 1 is fixed, and a casing 11 which covers the CCD 1 and optical element 10.

As shown in FIG. 4, the CCD 1 includes an optical receiver 2 at the center. Lead frames 3 are provided around the optical receiver 2 to hold the optical receiver 2 between them. The optical receiver 2 is electrically connected to the lead frames 3 through bonding wires 4. As shown in FIGS. 2 and 3, the optical receiver 2, lead frames 3, and bonding wires 4 are covered with a cover glass 5 made of transparent glass. Generally, the lead frames 3 and bonding wires 4 are made of metals having high reflectances. The lead frames 3 project from the side surface of the CCD 1, and are wired on the substrate 6 having a built-in electrical circuit.

As shown in FIGS. 2 and 3, the dustproof light-shielding member 7 formed of an elastic member is mounted on the CCD 1 so as to cover it like a lid. As shown in FIG. 5, the dustproof light-shielding member 7 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm. The dustproof light-shielding member 7 has an opening 9 which allows light to pass. The opening 9 has such a size that it does not come into contact with a light ray L having a maximum width of the light that can be received by the optical receiver 2.

For example, the optical element 10 is a low-pass filter which blocks a signal having a wavelength lower than a predetermined frequency and is placed on the dustproof light-shielding member 7. The optical element 10 is so arranged as to oppose the optical receiver 2.

The casing 11 formed like a recess is fixed to the substrate 6 with screws, packaging the CCD 1 fixed to the substrate 6, the dustproof light-shielding member 7 arranged to cover the CCD 1 like a lid, and the optical element 10 arranged to ride on the dustproof light-shielding member 7. The casing 11 has an opening 12 which allows light entering the CCD 1 to pass. The opening 12 has such a size that it does not come into contact with the light ray L.

A width 13a of a recess 13 of the casing 11 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

In this imaging device, light from an object passes through the opening 12, is transmitted through the optical element 10, passes through the opening 9, is transmitted through the cover glass 5, and is focused to form an image on the optical receiver 2. In order to prevent image deterioration caused by diffused reflection or the like, the dustproof light-shielding member 7 effectively shields portions other than the optical receiver 2, such as the lead frames 3 or the bonding wires 4, from light.

In the assembly, the CCD 1 and dustproof light-shielding member 7 are fitted at the fitting portion 8, eliminating the need for position adjustment of the optical receiver 2 and opening 9 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 11 further facilitates the assembly.

The optical element 10 is urged by the casing 11, squeezing the dustproof light-shielding member 7 to form a sealed space 19 between the CCD 1 and optical element 10. The dustproof light-shielding member 7 has a sufficient thickness to be squeezed.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

### Second Embodiment

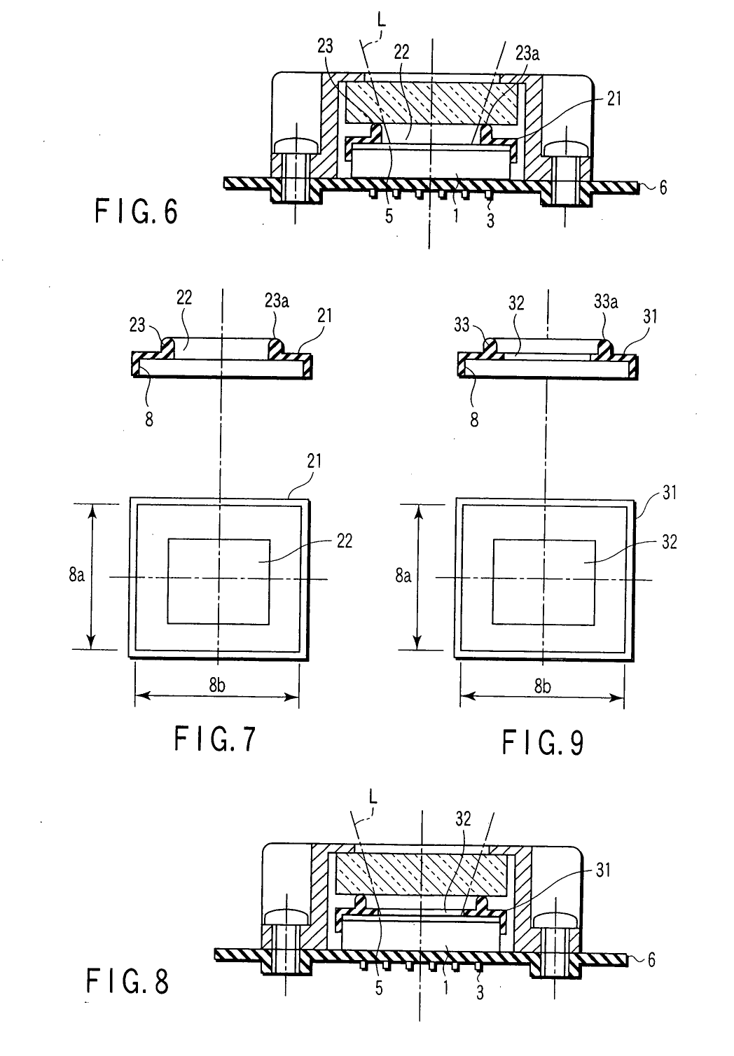

FIG. 6 is a cross-sectional view of an imaging device according to the second embodiment of the present invention. FIG. 7 shows the dustproof light-shielding member shown in FIG. 6. In the description, the same components as in the first embodiment are denoted by the same reference numerals.

As shown in FIG. 6, a dustproof light-shielding member 21 formed of an elastic member is mounted on a CCD 1 so as to cover it like a lid. As shown in FIG. 7, the dustproof light-shielding member 21 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm.

The dustproof light-shielding member 21 has an opening 22 which allows light to pass. The opening 22 has such a size that it does not come into contact with a light ray L having a maximum width of the light that can be received by an optical receiver 2. The dustproof light-shielding member 21 also has a projection 23 projecting toward the CCD 1 and surrounding the opening 22 continuously with adjacent to it. A distal end 23a of the projection 23 has a rounded or angled shape. For example, an optical element 10 is a low-pass filter which blocks a signal having a wavelength lower than a predetermined frequency. The optical element 10 is placed on the projection 23 of the dustproof light-shielding member 21 and so arranged as to oppose the optical receiver 2 of the CCD 1.

A casing 11 is so arranged as to cover the CCD 1 fixed to a substrate 6, the dustproof light-shielding member 21 arranged to cover the CCD 1 like a lid, and the optical element 10 arranged to ride on the dustproof light-shielding member 21, and is fixed to the substrate 6 with screws. The casing 11 has an opening 12 which allows light to pass. The opening 12 is sufficiently larger than the opening 22 of the dustproof light-shielding member 21 and smaller than the outer diameter of the optical element 10.

A width 13a of a recess 13 of the casing 11 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

In this imaging device, light from an object passes through the opening 12, is transmitted through the optical element 10, passes through the opening 22, is transmitted through a cover glass 5, and is focused to form an image on the optical receiver 2. In order to prevent image deterioration caused by diffused reflection or the like, the dustproof light-shielding member 21 effectively shields portions other than the optical receiver 2, such as the lead frames 3 or the bonding wires 4, from light.

In the assembly, the CCD 1 and dustproof light-shielding member 21 are fitted at the fitting portion 8, eliminating the need for position adjustment of the optical receiver 2 and opening 22 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 11 further facilitates the assembly.

The optical element 10 is urged by the casing 11, slightly squeezing the projection 23 of the dustproof light-shielding member 21 to form a sealed space 19 between the CCD 1 and optical element 10. The projection 23 supports the optical element 10 with its distal end 23a by line contact. Accordingly, the force required for squeezing the projection 23 may be smaller than the force required for urging it by surface contact. The presence of the projection 23 allows thickness reduction of the other portions, leading to cost reduction.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

[Modification to Second Embodiment]

FIG. 8 is a cross-sectional view of an imaging device according to a modification to the second embodiment of the present invention. FIG. 9 shows the dustproof light-shielding member shown in FIG. 8. In the description of this modification, the same components as in the second embodiment described above are denoted by the same reference numerals.

As shown in FIG. 8, a dustproof light-shielding member 31 formed of an elastic member is mounted on a CCD 1 so as to cover it like a lid. As shown in FIG. 9, the dustproof light-shielding member 31 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm.

The dustproof light-shielding member 31 has an opening 32 which allows light to pass. The opening 32 has such a size that it does not come into contact with a light ray L having a maximum width of the light that can be received by an optical receiver 2. The dustproof light-shielding member 31 also has a projection 33 projecting toward the CCD 1 and surrounding the opening 32 continuously. The projection 33 is located outside the opening 32 to be spaced apart from it by several mm. A distal end 33a of the projection 33 has a rounded or angled shape. For example, an optical element 10 is a low-pass filter which blocks a signal having a wavelength lower than a predetermined frequency. The optical element 10 is placed on the projection 33 of the dustproof light-shielding member 31 and so arranged as to oppose the optical receiver 2 of the CCD 1.

A casing 11 is so arranged as to cover the CCD 1 fixed to a substrate 6, the dustproof light-shielding member 31 arranged to cover the CCD 1 like a lid, and the optical element 10 arranged to ride on the dustproof light-shielding member 31, and is fixed to the substrate 6 with screws. The casing 11 has an opening 12 which allows light to pass. The opening 12 is sufficiently larger than the opening 32 of the dustproof light-shielding member 31 and smaller than the outer diameter of the optical element 10.

A width 13a of a recess 13 of the casing 11 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

In this imaging device, light from an object passes through the opening 12, is transmitted through the optical element 10, passes through the opening 22, is transmitted through a cover glass 5, and is focused to form an image on the optical receiver 2. In order to prevent image deterioration caused by diffused reflection or the like, the dustproof light-shielding member 31 effectively shields portions other than the optical receiver 2, such as the lead frames 3 or the bonding wires 4, from light.

In the assembly, the CCD 1 and dustproof light-shielding member 31 are fitted at the fitting portion 8, eliminating the need for position adjustment of the optical receiver 2 and opening 32 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 11 further facilitates the assembly.

The optical element 10 is urged by the casing 11, slightly squeezing the projection 33 of the dustproof light-shielding member 31 to form a sealed space 19 between the CCD 1 and optical element 10. The projection 33 supports the optical element 10 with its distal end 33a by line contact. Accordingly, the force required for squeezing the projection 33 may be smaller than the force required for urging it by surface contact. The presence of the projection 33 allows thickness reduction of the other portions, leading to cost reduction.

The projection 33 is formed outside the opening 32 to be spaced apart from it by several mm, allowing the opening area of the opening 32 to be smaller than the area of the opening 22 while maintaining the light ray L. Thus, unnecessary portions other than the optical receiver 2, such as the lead frames 3 or the bonding wires 4, can be shielded from light more reliably.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

### Third Embodiment

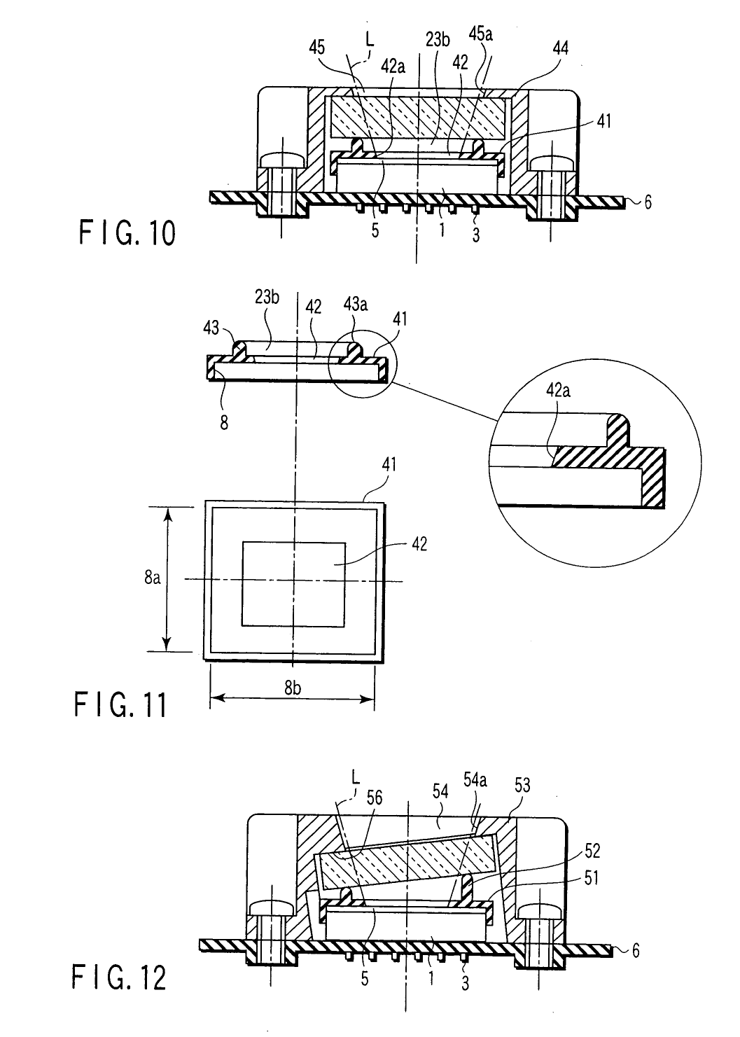

FIG. 10 is a cross-sectional view of an imaging device according to the third embodiment of the present invention. FIG. 11 shows the dustproof light-shielding member shown in FIG. 10. In the description, the same components as in the second embodiment described above are denoted by the same reference numerals.

As shown in FIG. 10, a dustproof light-shielding member 41 formed of an elastic member is mounted on a CCD 1 so as to cover it like a lid. As shown in FIG. 11, the dustproof light-shielding member 41 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm.

The dustproof light-shielding member 41 has an opening 42 which allows light to pass. The opening 42 has such a size that it does not come into contact with a light ray L having a maximum width of the light that can be received by an optical receiver 2. An inner wall 42a of the opening 42 is slanted so as to expand radially from a CCD 1 side toward an optical element 10 side. The dustproof light-shielding member 41 also has a projection 43 projecting toward the CCD 1 and surrounding the opening 42 continuously. The projection 43 is located outside the opening 42 to be spaced apart from it by several mm. A distal end 43a of the projection 43 has a rounded or angled shape. For example, the optical element 10 is a low-pass filter which blocks a signal having a wavelength lower than a predetermined frequency. The optical element 10 is placed on the projection 43 of the dustproof light-shielding member 41 and so arranged as to oppose the optical receiver 2 of the CCD 1.

A casing 44 is so arranged as to cover the CCD 1 fixed to a substrate 6, the dustproof light-shielding member 41 arranged to cover the CCD 1 like a lid, and the optical element 10 arranged to ride on the dustproof light-shielding member 41, and is fixed to the substrate 6 with screws. The casing 44 has an opening 45 which allows light to pass. The opening 45 is sufficiently larger than the opening 42 of the dustproof light-shielding member 41 and smaller than the outer diameter of the optical element 10. An inner wall 45a of the opening 45 is slanted so as to expand from the CCD 1 side toward the optical element 10 side.

A width 13a of a recess 13 of the casing 44 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

In this imaging device, light from an object passes through the opening 45, is transmitted through the optical element 10, passes through the opening 42, is transmitted through a cover glass 5, and is focused to form an image on the optical receiver 2. In order to prevent image deterioration caused by diffused reflection or the like, the dustproof light-shielding member 41 effectively shields portions other than the optical receiver 2, such as the lead frames 3 or the bonding wires 4, from light.

In the assembly, the CCD 1 and dustproof light-shielding member 41 are fitted at the fitting portion 8, eliminating the need for position adjustment of the optical receiver 2 and opening 42 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 11 further facilitates the assembly.

The optical element 10 is urged by the casing 44, slightly squeezing the projection 43 of the dustproof light-shielding member 41 to form a sealed space 19 between the CCD 1 and optical element 10. The projection 43 supports the optical element 10 with its distal end 43a by line contact. Accordingly, the force required for squeezing the projection 43 may be smaller than the force required for urging it by surface contact. The presence of the projection 43 allows thickness reduction of the other portions, leading to cost reduction.

The projection 43 is formed outside the opening 42 to be spaced apart from it by several mm, allowing the area of the opening 42 to be smaller than the area of the opening 22 while maintaining the light ray L. Thus, unnecessary portions other than the optical receiver 2, such as the lead frames 3 or the bonding wires 4, can be shielded from light more reliably. The slant inner walls 42a and 45a of the openings 42 and 45 allow further reduction of the opening areas to be smaller than the opening area shown in FIG. 9. As a result, unnecessary portions can be shielded from light more reliably.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

[Modification to Third Embodiment]

This embodiment is a modification of part of the dustproof light-shielding member 41 of the third embodiment. Hence, this embodiment will be described with reference to FIGS. 10 and 11. In the description of this modification, the same components as in the third embodiment described above are denoted by the same reference numerals.

A dustproof light-shielding member 41 formed of an elastic member is mounted on a CCD 1 so as to cover it like a lid. The dustproof light-shielding member 41 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm.

The dustproof light-shielding member 41 has an opening 42 which allows light to pass. The opening 42 has such a size that it does not come into contact with a light ray L having a maximum width of the light that can be received by an optical receiver 2. An inner wall 42a of the opening 42 is slanted so as to expand radially from a CCD 1 side toward an optical element 10 side. The dustproof light-shielding member 41 also has a projection 43 projecting toward the CCD 1 and surrounding the opening 42 continuously. The projection 43 is located outside the opening 42 to be spaced apart from it by several mm. A distal end 43a of the projection 43 has a rounded or angled shape. For example, the optical element 10 is a low-pass filter which blocks a signal having a wavelength lower than a predetermined frequency. The optical element 10 is placed on the projection 43 of the dustproof light-shielding member 41 and so arranged as to oppose the optical receiver 2 of the CCD 1.

The surface of that inner wall of the dustproof light-shielding member 41 which is surrounded by the optical element 10, CCD 1, and dustproof light-shielding member 41 is subjected to a surface roughening process with a roughness of 0 to 200.

A casing 44 is so arranged as to cover the CCD 1 fixed to a substrate 6, the dustproof light-shielding member 41 arranged to cover the CCD 1 like a lid, and the optical element 10 arranged to ride on the dustproof light-shielding member 41, and is fixed to the substrate 6 with screws. The casing 44 has an opening 45 which allows light to pass. The opening 45 is sufficiently larger than the opening 42 of the dustproof light-shielding member 41 and smaller than the outer diameter of the optical element 10. An inner wall 45a of the opening 45 is slanted so as to expand from the CCD 1 side toward the optical element 10 side.

A width 13a of a recess 13 of the casing 44 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

In this imaging device, light from an object passes through the opening 45, is transmitted through the optical element 10, passes through the opening 42, is transmitted through a cover glass 5, and is focused to form an image on the optical receiver 2. In order to prevent image deterioration caused by diffused reflection or the like, the dustproof light-shielding member 41 effectively shields portions other than the optical receiver 2, such as the lead frames 3 or the bonding wires 4, from light.

In the assembly, the CCD 1 and dustproof light-shielding member 41 are fitted at the fitting portion 8, eliminating the need for position adjustment of the optical receiver 2 and opening 42 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 11 further facilitates the assembly.

The optical element 10 is urged by the casing 44, slightly squeezing the projection 43 of the dustproof light-shielding member 41 to form a sealed space 19 between the CCD 1 and optical element 10. The projection 43 supports the optical element 10 with its distal end 43a by line contact. Accordingly, the force required for squeezing the projection 43 may be smaller than the force required for urging it by surface contact. The presence of the projection 43 allows thickness reduction of the other portions, leading to cost reduction.

The projection 43 is formed outside the opening 42 to be spaced apart from it by several mm, allowing the area of the opening 42 to be smaller than the area of the opening 22 while maintaining the light ray L. Thus, unnecessary portions other than the optical receiver 2, such as the lead frames 3 or the bonding wires 4, can be shielded from light more reliably. The slant inner walls 42a and 45a of the openings 42 and 45 allow further reduction of the opening areas to be smaller than the opening area of the opening 32 shown in FIG. 9. As a result, unnecessary portions can be shielded from light more reliably.

The inner wall 42a of the opening 42 of the dustproof light-shielding member 41, an inner wall 43b of the projection 43 of the dustproof light-shielding member 41, and a portion between the inner walls 42a and 43b are subjected to a surface roughening process, serving as antireflective portions to prevent stray light, diffused reflection, and the like between the optical element 10 and optical receiver 2.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

### Fourth Embodiment

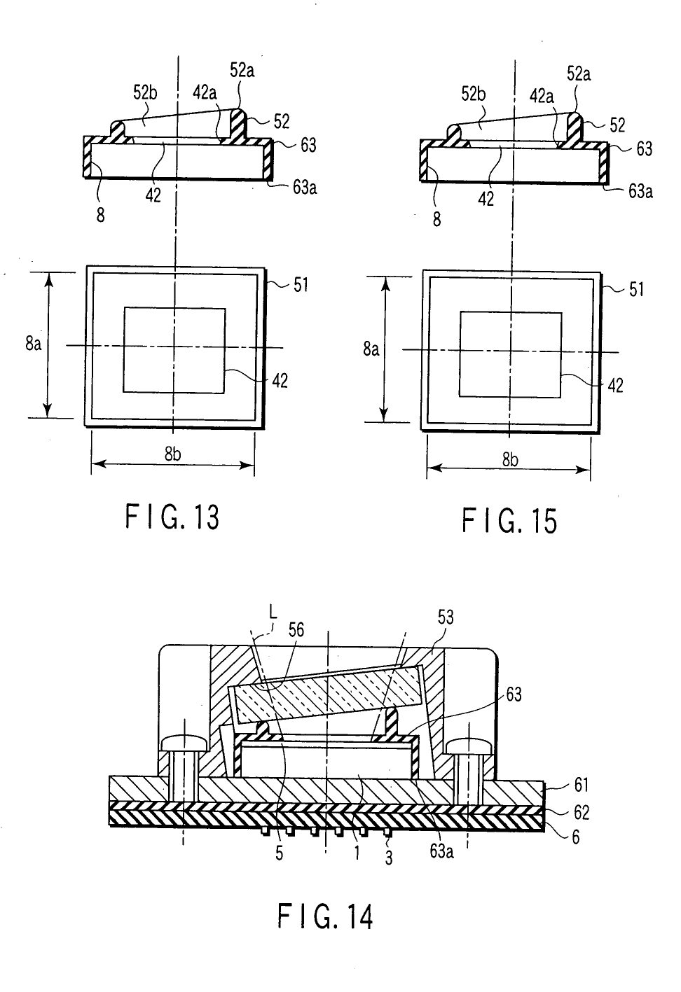

FIG. 12 is a cross-sectional view of an imaging device according to the fourth embodiment of the present invention. FIG. 13 shows the dustproof light-shielding member shown in FIG. 12. In the description, the same components as in the third embodiments are denoted by the same reference numerals.

As shown in FIG. 12, a dustproof light-shielding member 51 formed of an elastic member is mounted on a CCD 1 so as to cover it like a lid. As shown in FIG. 13, the dustproof light-shielding member 51 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm.

The dustproof light-shielding member 51 has an opening 42 which allows light to pass. The opening 42 has such a size that it does not come into contact with a light ray L having a maximum width of the light that can be received by an optical receiver 2. An inner wall 42a of the opening 42 is slanted so as to expand radially from a CCD 1 side toward an optical element 10 side. The dustproof light-shielding member 51 also has a projection 52 projecting toward the CCD 1 and surrounding the opening 42 continuously. The projection 52 is located outside the opening 42 to be spaced apart from it by several mm. A distal end 52a of the projection 52 has a rounded or angled shape. The upper surface of the projection 52 is slanted with respect to the light-receiving surface of the optical receiver 2. For example, an optical element 10 is a low-pass filter which blocks a signal having a wavelength lower than a predetermined frequency. The optical element 10 is placed on the projection 52 of the dustproof light-shielding member 51 and so arranged as to oppose the optical receiver 2 of the CCD 1. The inner wall of that portion of the dustproof light-shielding member 51 which is surrounded by the optical element 10, CCD 1, and dustproof light-shielding member 51 is subjected to a surface roughening process with a roughness of 0 to 200.

A casing 53 is so arranged as to cover the CCD 1 fixed to a substrate 6, the dustproof light-shielding member 51 arranged to cover the CCD 1 like a lid, and the optical element 10 supported aslant by the projection 52 of the dustproof light-shielding member 51, and is fixed to the substrate 6 with screws. The casing 53 has an opening 54 which allows light to pass. The opening 54 is sufficiently larger than the opening 42 of the dustproof light-shielding member 51 and smaller than the outer diameter of the optical element 10. An inner wall 54a of the opening 54 is slanted so as to expand from a CCD 1 side toward an optical element 10 side.

A width 13a of a recess 13 of the casing 53 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

A surface 56 of the recess 13 of the casing 53 which urges the optical element 10 is parallel to the slant upper surface of the projection 52.

In this imaging device, light from an object passes through the opening 54, is transmitted through the optical element 10, passes through the opening 42, is transmitted through a cover glass 5, and is focused to form an image on the optical receiver 2. In order to prevent image deterioration caused by diffused reflection or the like, the dustproof light-shielding member 51 effectively shields portions other than the optical receiver 2, such as the lead frames 3 or the bonding wires 4, from light.

In the assembly, the CCD 1 and dustproof light-shielding member 51 are fitted at the fitting portion 8, eliminating the need for position adjustment of the optical receiver 2 and opening 42 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 53 further facilitates the assembly.

The optical element 10 is urged by the casing 53, slightly squeezing the projection 52 of the dustproof light-shielding member 51 to form a sealed space 19 between the CCD 1 and optical element 10. The projection 52 supports the optical element 10 with its distal end 52a by line contact. Accordingly, the force required for squeezing the projection 52 may be smaller than the force required for urging it by surface contact. The presence of the projection 52 allows thickness reduction of the other portions, leading to cost reduction.

The projection 52 is formed outside the opening 42 to be spaced apart from it by several mm, allowing the area of the opening 42 to be smaller than the area of the opening 22 of FIG. 7 while maintaining the light ray L. Thus, unnecessary portions other than the optical receiver 2, such as the lead frames 3 or the bonding wires 4, can be shielded from light more reliably. The slant inner walls 42a and 45a of the openings 42 and 45 allow further reduction of the opening areas to be smaller than the opening area of the opening 32 shown in FIG. 9. As a result, unnecessary portions can be shielded from light more reliably.

The inner wall 42a of the opening 42 of the dustproof light-shielding member 41, an inner wall 52b of the projection 52 of the dustproof light-shielding member 41, and a portion between the inner walls 42a and 52b are subjected to a surface roughening process, serving as antireflective portions to prevent stray light, diffused reflection, and the like between the optical element 10 and optical receiver 2.

Light from the object passes through the opening 54 of the casing 53, is transmitted through the optical element 10, passes through the opening 42 of the dustproof light-shielding member 51, is transmitted through the cover glass 5, and reaches the optical receiver 2. At this time, the light passing through the cover glass 5 is partly reflected by the light-receiving surface of the optical receiver 2, and passes through the cover glass 5 again to reach the optical element 10. Part of the light reaching the optical element 10 is reflected by the optical element 10 and reaches the optical receiver 2 again. This repetitive reflection at the same position is called spot flare that considerably degrades the image. The optical element 10 is mounted aslant with respect to the optical receiver 2, reflecting the light to be reflected by the optical element 10 aslant with respect to the light-receiving surface of the optical receiver 2, which prevents repetitive reflection at the same position, so that the light eventually goes outside the visual field and hits the inner wall of the casing 53 or the like to disappear. Accordingly, spot flare can be decreased.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

### Fifth Embodiment

FIG. 14 is a cross-sectional view of an imaging device according to the fifth embodiment of the present invention. FIG. 15 shows the dustproof light-shielding member shown in FIG. 14. In the description, the same components as in the fourth embodiments are denoted by the same reference numerals.

As shown in FIG. 14, the imaging device further includes a heat dissipation plate 61 which dissipates heat of a CCD 1. The heat dissipation plate 61 is made of a metal and arranged in tight contact with the bottom surface of the CCD 1. An insulating plate 62 formed of an insulating member is interposed between the heat dissipation plate 61 and a substrate 6. The heat dissipation plate 61 and insulating plate 62 have holes (not shown) through which lead frames 3 extend.

A dustproof light-shielding member 63 formed of an elastic member is mounted on the CCD 1 so as to cover it like a lid. As shown in FIG. 15, the dustproof light-shielding member 63 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm. A bottom surface 63a of the dustproof light-shielding member 63 is in tight contact with the heat dissipation plate 61.

The dustproof light-shielding member 63 has an opening 42 which allows light to pass. The opening 42 has such a size that it does not come into contact with a light ray L having a maximum width of the light that can be received by an optical receiver 2. An inner wall 42a of the opening 42 is slanted so as to expand radially from a CCD 1 side toward an optical element 10 side. The dustproof light-shielding member 63 also has a projection 52 projecting toward the CCD 1 and surrounding the opening 42 continuously. The projection 52 is located outside the opening 42 to be spaced apart from it by several mm. A distal end 52a of the projection 52 has a rounded or angled shape. The upper surface of the projection 52 is slanted with respect to the light-receiving surface of the optical receiver 2. For example, an optical element 10 is a low-pass filter which blocks a signal having a wavelength lower than a predetermined frequency. The optical element 10 is placed on the projection 52 of the dustproof light-shielding member 63 and so arranged as to oppose the optical receiver 2 of the CCD 1. The inner wall of that portion of the dustproof light-shielding member 63 which is surrounded by the optical element 10, CCD 1, and dustproof light-shielding member 63 is subjected to a surface roughening process with a roughness of 0 to 200.

A casing 53 is so arranged as to cover the CCD 1 fixed to a substrate 6, the dustproof light-shielding member 63 arranged to cover the CCD 1 like a lid, and the optical element 10 supported aslant by the projection 52 of the dustproof light-shielding member 63, and is fixed to the substrate 6 with screws. The casing 53 has an opening 54 which allows light to pass. The opening 54 is sufficiently larger than the opening 42 of the dustproof light-shielding member 63 and smaller than the outer diameter of the optical element 10. An inner wall 54a of the opening 54 is slanted so as to expand from a CCD 1 side toward an optical element 10 side.

A width 13a of a recess 13 of the casing 53 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

A surface 56 of the recess 13 of the casing 53 which urges the optical element 10 is parallel to the slant upper surface of the projection 52.

In this imaging device, light from an object passes through the opening 54, is transmitted through the optical element 10, passes through the opening 42, is transmitted through a cover glass 5, and is focused to form an image on the optical receiver 2. In order to prevent image deterioration caused by diffused reflection or the like, the dustproof light-shielding member 63 effectively shields portions other than the optical receiver 2, such as the lead frames 3 or the bonding wires 4, from light.

In the assembly, the CCD 1 and dustproof light-shielding member 63 are fitted at the fitting portion 8, eliminating the need for position adjustment of the optical receiver 2 and opening 42 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 53 further facilitates the assembly.

The optical element 10 is urged by the casing 53, slightly squeezing the projection 52 of the dustproof light-shielding member 63 to form a sealed space 19 between the CCD 1 and optical element 10. The projection 52 supports the optical element 10 with its distal end 52a by line contact. Accordingly, the force required for squeezing the projection 52 may be smaller than the force required for urging it by surface contact. The presence of the projection 52 allows thickness reduction of the other portions, leading to cost reduction.

The projection 52 is formed outside the opening 42 to be spaced apart from it by several mm, allowing the area of the opening 42 to be smaller than the area of the opening 22 of FIG. 7 while maintaining the light ray L. Thus, unnecessary portions other than the optical receiver 2, such as the lead frames 3 or the bonding wires 4, can be shielded from light more reliably. The slant inner walls 42a and 45a of the openings 42 and 45 allow further reduction of the opening areas to be smaller than the opening area of the opening 32 shown in FIG. 9. As a result, unnecessary portions can be shielded from light more reliably.

The inner wall 42a of the opening 42 of the dustproof light-shielding member 63, an inner wall 52b of the projection 52 of the dustproof light-shielding member 63, and a portion between the inner walls 42a and 52b are subjected to a surface roughening process, serving as antireflective portions to prevent stray light, diffused reflection, and the like between the optical element 10 and optical receiver 2.

Light from the object passes through the opening 54 of the casing 53, is transmitted through the optical element 10, passes through the opening 42 of the dustproof light-shielding member 63, is transmitted through the cover glass 5, and reaches the optical receiver 2. At this time, the light passing through the cover glass 5 is partly reflected by the light-receiving surface of the optical receiver 2, and passes through the cover glass 5 again to reach the optical element 10. Part of the light reaching the optical element 10 is reflected by the optical element 10 and reaches the optical receiver 2 again. This repetitive reflection at the same position is called spot flare that considerably degrades the image. The optical element 10 is mounted aslant with respect to the optical receiver 2, reflecting the light to be reflected by the optical element 10 aslant with respect to the light-receiving surface of the optical receiver 2, which prevents repetitive reflection at the same position, so that the light eventually goes outside the visual field and hits the inner wall of the casing 53 or the like to disappear. Accordingly, spot flare can be decreased.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

The heat dissipation plate 61 has larger thermal conductivity than the optical element 10. Heat generated by the CCD 1 is conducted from the bottom surface of the CCD 1 to the heat dissipation plate 61 and dissipated. Heat generated in the upper and side surfaces of the CCD 1 is conducted from the dustproof light-shielding member 63 in tight contact with the side and upper surfaces of the CCD 1, to the heat dissipation plate 61 and dissipated. Hence, the CCD 1 can be cooled efficiently. As a result, thermal noise can be decreased.

### Sixth Embodiment

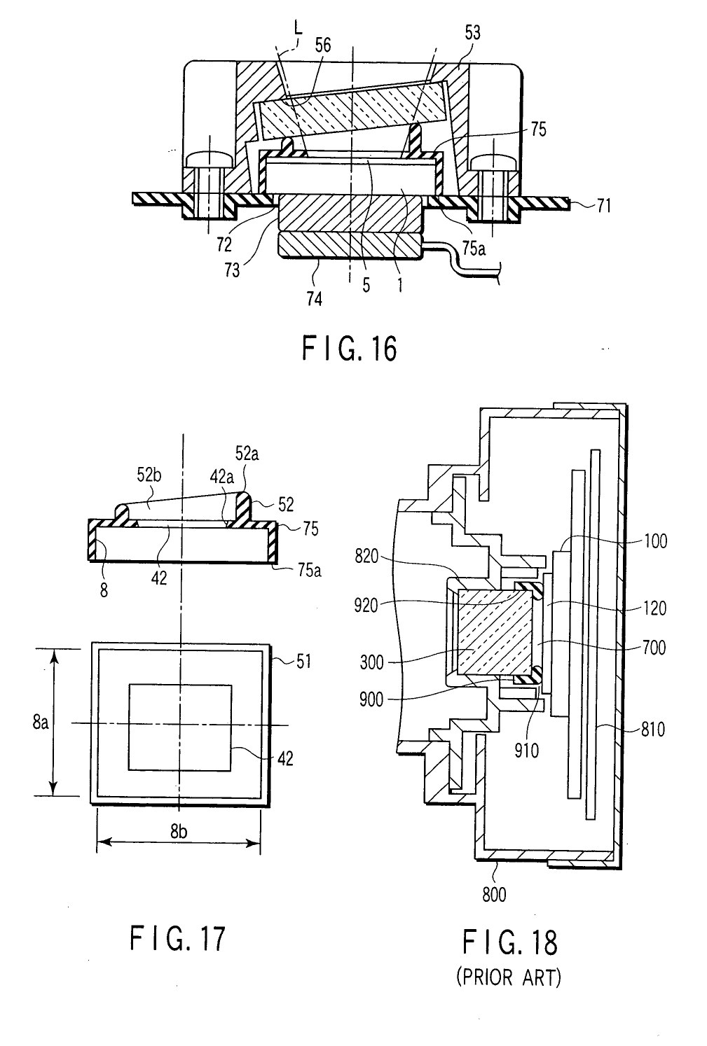

FIG. 16 is a cross-sectional view of an imaging device according to the sixth embodiment of the present invention. FIG. 17 shows the dustproof light-shielding member shown in FIG. 16. In the description, the same components as in the fourth embodiment are denoted by the same reference numerals.

As shown in FIG. 16, the imaging device further includes a Peltier element 74 which cools a CCD 1. A substrate 71, to which CCD 1 is fixed, has an opening 72 which allows the bottom surface of the CCD 1 element to be exposed. A cooling plate 73 is fixed to the bottom surface of the CCD 1 element in tight contact with it. The Peltier element 74 is fixed to the cooling plate 73 in tight contact with it. The cooling plate 73 is made of a material having large thermal conductivity, e.g., a metal. When a current is supplied to the Peltier element 74, the temperature of one side of the Peltier element 74 becomes low while that on the other side becomes high. The Peltier element 74 is fixed with its low-temperature side in tight contact with the cooling plate 73.

A dustproof light-shielding member 75 made of a heat-insulating material is mounted on the CCD 1 so as to cover it like a lid. As the heat-insulating material, for example, polypropylene is employed. As shown in FIG. 17, the dustproof light-shielding member 75 has a fitting portion 8 formed like a recess in which the CCD 1 is to be fitted. A fitting length 8a is larger than a length 1a of the side surface of the CCD 1 by approximately 0 mm to 0.2 mm. A fitting length 8b is larger than a length 1b of the side surface of the CCD 1 by approximately 0 mm to 0.2 mm. A bottom surface 75a of the dustproof light-shielding member 75 is in tight contact with the heat dissipation plate 61.

The dustproof light-shielding member 75 has an opening 42 which allows light to pass. The opening 42 has such a size that it does not come into contact with a light ray L having a maximum width of the light that can be received by an optical receiver 2. An inner wall 42a of the opening 42 is slanted so as to expand radially from a CCD 1 side toward an optical element 10 side. The dustproof light-shielding member 75 also has a projection 52 projecting toward the CCD 1 and surrounding the opening 42 continuously. The projection 52 is located outside the opening 42 to be spaced apart from it by several mm. A distal end 52a of the projection 52 has a rounded or angled shape. The upper surface of the projection 52 is slanted with respect to the light-receiving surface of the optical receiver 2. For example, an optical element 10 is a low-pass filter which blocks a signal having a wavelength lower than a predetermined frequency. The optical element 10 is placed on the projection 52 of the dustproof light-shielding member 75 and so arranged as to oppose the optical receiver 2 of the CCD 1. The inner wall of that portion of the dustproof light-shielding member 75 which is surrounded by the optical element 10, CCD 1, and dustproof light-shielding member 75 is subjected to a surface roughening process with a roughness of 0 to 200.

A casing 53 is so arranged as to cover the CCD 1 fixed to the substrate 71, the dustproof light-shielding member 75 arranged to cover the CCD 1 like a lid, and the optical element 10 supported aslant by the projection 52 of the dustproof light-shielding member 75, and is fixed to the substrate 71 with screws. The casing 53 has an opening 54 which allows light to pass. The opening 54 is sufficiently larger than the opening 42 of the dustproof light-shielding member 75 and smaller than the outer diameter of the optical element 10. An inner wall 54a of the opening 54 is slanted so as to expand from a CCD 1 side toward an optical element 10 side.

A width 13a of a recess 13 of the casing 53 is larger than a width 10a of the optical element 10 by 0.5 mm to 1 mm. A width 13b of the recess 13 is larger than a width 10b of the optical element 10 by 0.5 mm to 1 mm. A depth 13c of the recess 13 is slightly smaller than a height 14 from the upper surface of the substrate 6 to the upper surface of the optical element 10.

A surface 56 of the recess 13 of the casing 53 which urges the optical element 10 is parallel to the slant upper surface of the projection 52.

In this imaging device, light from an object passes through the opening 54, is transmitted through the optical element 10, passes through the opening 42, is transmitted through a cover glass 5, and is focused to form an image on the optical receiver 2. In order to prevent image deterioration caused by diffused reflection or the like, the dustproof light-shielding member 75 effectively shields portions other than the optical receiver 2, such as the lead frames 3 or the bonding wires 4, from light.

In the assembly, the CCD 1 and dustproof light-shielding member 75 are fitted at the fitting portion 8, eliminating the need for position adjustment of the optical receiver 2 and opening 42 after the mounting, which facilitates the assembly. This can prevent the factors of image deterioration, such as diffused reflection or eclipse of the light ray L caused by misalignment. Spacing wide between the widths 10a and 10b of the optical element 10 and the widths 13a and 13b of the recess 13 of the casing 53 further facilitates the assembly.

The optical element 10 is urged by the casing 53, slightly squeezing the projection 52 of the dustproof light-shielding member 75 to form a sealed space 19 between the CCD 1 and optical element 10. The projection 52 supports the optical element 10 with its distal end 52a by line contact. Accordingly, the force required for squeezing the projection 52 may be smaller than the force required for urging it by surface contact. The presence of the projection 52 allows thickness reduction of the other portions, leading to cost reduction.

The projection 52 is formed outside the opening 42 to be spaced apart from it by several mm, allowing the area of the opening 42 to be smaller than the area of the opening 22 of FIG. 7 while maintaining the light ray L. Thus, unnecessary portions other than the optical receiver 2, such as the lead frames 3 or the bonding wires 4, can be shielded from light more reliably. The slant inner walls 42a and 54a of the openings 42 and 54 allow further reduction of the opening areas to be smaller than the opening area of the opening 32 shown in FIG. 9. As a result, unnecessary portions can be shielded from light more reliably.

The inner wall 42a of the opening 42 of the dustproof light-shielding member 75, an inner wall 52b of the projection 52 of the dustproof light-shielding member 75, and a portion between the inner walls 42a and 52b are subjected to a surface roughening process, serving as antireflective portions to prevent stray light, diffused reflection, and the like between the optical element 10 and optical receiver 2.

Light from the object passes through the opening 54 of the casing 53, is transmitted through the optical element 10, passes through the opening 42 of the dustproof light-shielding member 75, is transmitted through the cover glass 5, and reaches the optical receiver 2. At this time, the light passing through the cover glass 5 is partly reflected by the light-receiving surface of the optical receiver 2, and passes through the cover glass 5 again to reach the optical element 10. Part of the light reaching the optical element 10 is reflected by the optical element 10 and reaches the optical receiver 2 again. This repetitive reflection at the same position is called spot flare that considerably degrades the image. The optical element 10 is mounted aslant with respect to the optical receiver 2, reflecting the light to be reflected by the optical element 10 aslant with respect to the light-receiving surface of the optical receiver 2, which prevents repetitive reflection at the same position, so that the light eventually goes outside the visual field and hits the inner wall of the casing 53 or the like to disappear. Accordingly, spot flare can be decreased.

The formation of the sealed space 19 protects the space between the CCD 1 and optical element 10 against dust. Thus, any unwanted material such as dust will not enter between the optical element 10 and optical receiver 2. Since no unwanted material is reflected in the image, image deterioration can be prevented.

The Peltier element 74 cools the CCD 1 through the cooling plate 73. The dustproof light-shielding member 75 made of the heat-insulating material seals the CCD 1. Thus, external heat will not readily flow into the CCD 1, and the CCD 1 can be cooled efficiently. As a result, thermal noise can be decreased. Also, the imaging device can be formed compact at a low cost in comparison to an imaging device to which a fan, a fin, or the like is provided for cooling.

So far the embodiments of the present invention have been described with reference to the accompanying drawing. However, the present invention is not limited to these embodiments, and various changes and modifications may be made without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An imaging device comprising:
an imager including an optical receiver;
an optical element located on an optical path extending to the optical receiver;
a substrate to which the imager is fixed;
a casing which covers the imager and the optical element; and
a dustproof light-shielding member interposed between the imager and the optical element, the dustproof light-shielding member including an opening which allows light to pass, and a fitting portion formed like a recess in which the imager is to be fitted, and being held between the imager and the optical element to form a sealed space, protecting a space between the imager and the optical element against dust.

2. A device according the claim 1, wherein the dustproof light-shield member includes a projection which projects toward an optical element side to continuously surround the opening.

3. A device according to claim 2, wherein the projection is spaced from the opening.

4. A device according to claim 3, wherein the opening of the dustproof light-shielding member has an inner wall slanted so as to expand from an imager side toward the optical element side.

5. A device according to claim 4, wherein the inner wall of the opening of the dustproof light-shielding member is subjected to a surface roughening process.

6. A device according to claim 2, wherein an upper surface of the projection of the dustproof light-shielding member is slantd with respect to the optical receiver of the imager, and a surface of the optical element arranged on the projection is slanted with respect to the light-receiving surface of the optical receiver.

7. A device according to claim 1, further comprising a heat dissipation plate which dissipates heat of the imager, the heat dissipation plate being arranged in tight contact with a bottom surface of the imager, so that the dustproof light-shielding member, the optical element, and the heat dissipation plate seal the imager.

8. A device according to claim 1, further comprising a cooling element which cools the imager, wherein the substrate has an opening which allows a bottom surface of the imager to be exposed, the cooling element is arranged in tight contact with the bottom surface of the imager, the dustproof light-shielding member is make of a material having large heat insulating properties, and the imager is sealed by the dustproof light-shielding member and the optical element except for the bottom surface.

9. A device according to claim 8, wherein the dustproof light-shielding member is made of polypropylene.
